(19) United States
(12) Patent Application Publication
(10) Pub. No.: US 2025/0112521 A1
(43) Pub. Date: Apr. 3, 2025

(54) ACTUATOR

(71) Applicant: AISIN CORPORATION, Kariya (JP)

(72) Inventors: Jun ABIKO, Kariya-shi (JP); Natsumi TAKAHASHI, Kariya-shi (JP)

(73) Assignee: AISIN CORPORATION, Kariya (JP)

(21) Appl. No.: 18/813,269

(22) Filed: Aug. 23, 2024

(30) Foreign Application Priority Data
Oct. 3, 2023 (JP) 2023-171815

(51) Int. Cl. H02K 7/06; B60G 11/27

(52) U.S. Cl. CPC H02K 7/06; B60G 11/27; B60G 2202/152

(57) ABSTRACT

A compact actuator with a simple structure is provided. An actuator includes: a motor including a stator and a rotor; at least one cylinder disposed adjacent to the motor; and a piston being attached to a drive shaft and provided in the cylinder, wherein the rotor has a hollow structure and the drive shaft is housed in the rotor in such a way that a part of the drive shaft is threadedly engaged with a part of the rotor while shaft centers thereof are coincident with each other, and the drive shaft is configured to reciprocate along the shaft center in conjunction with rotation of the rotor.

### CROSS REFERENCE TO RELATED APPLICATIONS

This application is based on and claims priority under 35 U.S.C. § 119 to Japanese Patent Application 2023-171815, filed on Oct. 3, 2023, the entire content of which is incorporated herein by reference.

### TECHNICAL FIELD

This disclosure generally relates to an actuator including a cylinder in which a piston is provided and a motor, the actuator being configured to reciprocate and drive the piston by means of rotary drive of the motor.

### BACKGROUND DISCUSSION

Conventional actuators as described above include, for example, one described in JP2009-298170A (see paragraphs [0011] to [0015] and [0026] and FIG. 1).

This actuator is also associated with an air suspension device of a vehicle. This device includes a cylinder 5 that communicates with a pair of air springs 2, and the cylinder 5 is partitioned inside into two chambers R1 and R2 by a piston 6. Displacing the piston 6 causes volumes in the air springs 2 to be varied. A drive source is a motor 7a, and rotational motion of the motor 7a is transmitted to the piston 6 through a motion conversion mechanism 7b.

The actuator does not adjust a vehicle height with compressed air being supplied from or discharged to an outside, but displaces the piston 6 in the cylinder 5 that communicates with each of the air springs 2, thereby performing attitude control of the vehicle body. Therefore, the actuator is not likely to be affected by compressibility of compressed air while the air is being supplied or discharged.

Since the actuator does not utilize a compressor or the like, compressed air is not released into atmosphere from the air spring 2, resulting in less energy loss. In addition, the actuator can perform highly responsive attitude control of a vehicle body, for example, by concurrently regulating pressure generated by the right and left air springs 2.

Furthermore, JP2009-298170A describes that, since the actuator does not require a high-capacity compressor and a high volume of compressed air is not required to be supplied to or discharged from the air springs 2, a size of the air suspension device is not increased and there is no concern for mounting the air suspension device on a vehicle.

In the conventional actuator as described above, rotational motion of the motor 7a is converted into linear motion of the piston 6 through the motion conversion mechanism 7b. As the motion conversion mechanism 7b, for example, a combination of a threaded shaft provided on an outer periphery of one end of a rod 6a and a nut coupled to the motor 7a in such a way as to threadedly engage with the threaded shaft, a combination of a rack formed at one end of the rod 6a and a worm gear coupled to the motor 7a in such a way as to engage with the rack, or the like is used.

However, in all of these configurations, the motor 7a is connected to a different gear or the like and rotary drive of the gear is transmitted to the rod 6a of the piston 6. Therefore, a predetermined space is required for arranging these members. In order to engage a rotating shaft of the motor 7a with the rod 6a for reliable transmission, these members need to be correctly aligned with each other, which increases a burden in structural design of connected portions and machining of the members.

Thus, conventional actuators have various problems to be solved, in particular, in a mechanism that converts rotary drive of a motor into linear drive of a piston, and a compact actuator with a simple structure has been desired.

A need thus exists for an actuator, which is not susceptible to the drawback mentioned above.

### SUMMARY

An actuator according to this disclosure includes: a motor including a stator and a rotor; at least one cylinder disposed adjacent to the motor; and a piston attached to a drive shaft and provided in the cylinder, wherein the rotor has a hollow structure and the drive shaft is housed in the rotor in such a way that a part of the drive shaft is threadedly engaged with a part of the rotor and shaft centers thereof are coincident with each other, and the drive shaft is configured to reciprocate along the shaft center in conjunction with rotation of the rotor.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory diagram illustrating a mode of use of an actuator according to a first embodiment;

FIG. 2 is a cross-sectional view illustrating a structure of the actuator according to the first embodiment;

FIG. 3 is a perspective view illustrating the structure of the actuator according to the first embodiment;

FIG. 4 is a cross-sectional view illustrating a structure of an actuator according to a second embodiment; and

FIG. 5 is a perspective view illustrating the structure of the actuator according to the second embodiment.

### DETAILED DESCRIPTION

### First Embodiment

### Outline

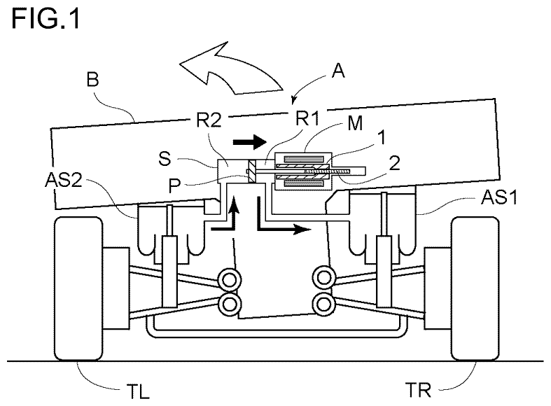

An actuator A according to a first embodiment of this disclosure is illustrated in FIG. 1 to FIG. 3. The actuator A includes a motor M and a cylinder S, which are integrated together, converts rotational motion of the motor M into reciprocating motion, and transmits the reciprocating motion to a piston P provided in the cylinder S. The actuator A is used, for example, in an air suspension device of a vehicle B.

As illustrated by way of example in FIG. 1, a single actuator A according to this disclosure is provided for right and left wheels in the vehicle B in which a right wheel TR and a left wheel TL are supported by two chambers, that is, two air springs AS. FIG. 1 is a diagram of the vehicle B viewed along a traveling direction while the vehicle B is turning left. A cylinder S is provided in the middle of the actuator A, and a piston P is positioned at the center of the cylinder S in a neutral state. An internal space of the cylinder S is partitioned by the piston P into a first chamber R1 and a second chamber R2, which are respectively located on the right and the left of the piston P. The first chamber R1 is connected to a first air spring AS1 in the right wheel TR and the second chamber R2 is connected to a second air spring AS2 in the left wheel TL.

In the present configuration, by pressurizing the air spring AS1 located outside and depressurizing the air spring AS2 located inside while the vehicle B is turning, an attitude of the vehicle B during rolling can be controlled to reduce change in the attitude. To achieve this, a value of lateral g is calculated from a result of detection by a vehicle speed sensor and a steering angle sensor, the piston P is displaced in a direction in which the first chamber R1 is contracted, and air is supplied to the air spring AS1 located outside while the vehicle B is turning.

The present configuration can reduce thrust of the motor M that drives the piston

P. For example, while the vehicle B is turning, since the vehicle is inclined to the outside, the air spring AS1 located outside is pressurized and the air spring AS2 located inside is depressurized, which causes a vehicle height to be increased. In this case, in order to stabilize the attitude of the vehicle B, the motor M is driven to displace the piston P, and differential pressure generated in the air springs AS1 and AS2 just needs to be the same as the differential pressure to be generated in the left and right wheels TL and TR. Thus, the present configuration can reduce load on the motor M and downsize the actuator A.

Although illustration is omitted, it is to be noted that the two chambers, that is, the first chamber R1 and the second chamber R2 formed by the cylinder S and the piston P may be connected to air springs AS associated with front and rear wheels. When the air springs AS are associated with the front and rear wheels, by depressurizing the air spring AS associated with the front wheel and pressurizing the air spring AS associated with the rear wheel while the vehicle B is climbing a level difference, the attitude of the vehicle B during pitching can be controlled to reduce change in the attitude.

Thus, by controlling the attitude of the vehicle B during rolling or pitching, performances of the vehicle B in turning and climbing a level difference can be improved. In addition, by inclining the vehicle B while being stopped can make getting in or out of the vehicle B easier. Furthermore, the actuator A provided may be easily additionally attached to the air suspension that has been already mounted to the vehicle B, and the actuator A is highly versatile.

### Motor and Stroke Sensor

As the motor M, various types of motors that include a stator M2 and a rotor M1 may be employed. Although an amount of rotation of the motor M determines displacement of the piston P, in the present embodiment, the displacement of the piston P is measured, for example, by using a stroke sensor 9.

Specifically, in order to measure displacement of an externally threaded shaft 2, the stroke sensor 9 is disposed in such a way as to extend from a distal end of the externally threaded shaft 2 to a first housing H1. The stroke sensor 9 can directly measure a motion of an end of the externally threaded shaft 2 and easily and reliably ensures identification of a position of the piston P. In addition, wiring from the stroke sensor 9 to the motor M or the like is easy, which enables reliability to be improved and costs to be reduced. Other than using the stroke sensor 9, an encoder or a resolver may be provided in a part of the rotor M1 to measure the amount of rotation or an angle of rotation of the motor M1 for identification of the displacement of the piston P.

### Control Board

The displacement of the piston P is controlled by a control board 5 provided in the first housing H1. Although illustration is omitted, the vehicle speed sensor and the steering angle sensor is provided in the vehicle B. Using a vehicle speed and a steering angle measured by these sensors, the control board 5 calculates the value of lateral g applied to the vehicle B while steering is performed. In the control board 5, a map associating the value of lateral g with a stroke of the piston P is stored, and feedforward control can be performed on the motor M.

### Cylinder & Piston

The cylinder S is also provided in the first housing H1 in which the motor M is provided. In the present embodiment, the motor M and the cylinder S have a substantially cylindrical shape. The piston P supported by the drive shaft is provided in the cylinder S in such a way that the piston P can reciprocate. Specifically, by constructing the cylinder S using a cylindrical member in such a way that the cylinder S has a through-type structure in which both ends of the cylinder S are open, manufacturing the cylinder S becomes easy.

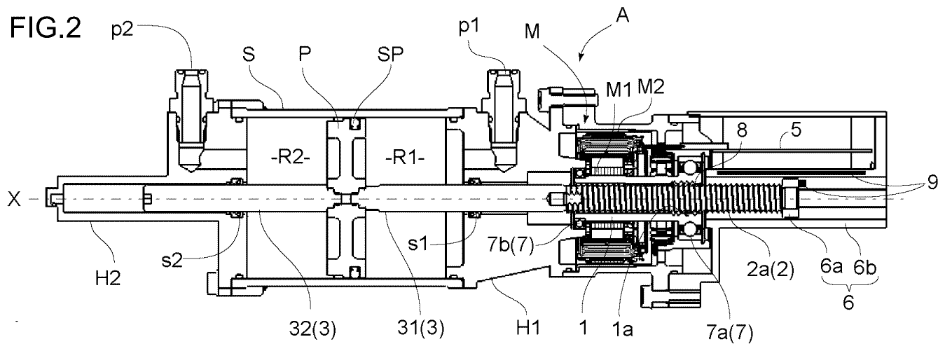

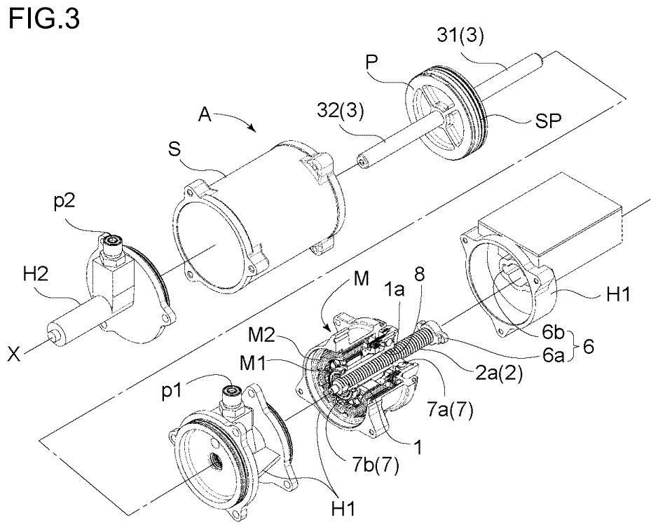

The cylinder S is partitioned inside by the piston P into the first chamber R1 and the second chamber R2, and expanded states and contracted states of these chambers alternate. As illustrated in FIG. 2 and FIG. 3, the piston P is threadedly connected with the first shaft 31 and the second shaft 32 that serve as a drive shaft 3. The first shaft 31 and the second shaft 32 are shaped to have the same length as the stroke of the piston P.

The cylinder S is cylindrically shaped in such a way that the piston P can slide in the cylinder S. One end of the cylinder S is engaged with the first housing H1 in which the motor M is provided by fitting the cylinder S around the housing H1 and fastening the cylinder S onto the housing at a flange with a bolt or the like in such a way that axes of the cylinder S and the housing are aligned and the other end of the cylinder S is similarly engaged with the second housing H2 by fitting the cylinder S around the housing H2 and fastening the cylinder S onto the housing at a flange with a bolt or the like in such a way that axes of the cylinder S and the housing are aligned. Since the first housing H1 substitutes as a bottom of the cylinder S, a shaft center of the first shaft 31 is coincident with a shaft center of the externally threaded shaft 2 with high precision, serving as a shaft center X.

The first shaft 31 is airtightly supported by a first seal s1 provided in the first housing H1 and the second shaft 32 is airtightly supported by a second seal s2 provided in the second housing H2. An annular piston seal SP is attached to an outer periphery of the piston P and the piston P reciprocates in close contact with an inner wall of the cylinder S. A first port p1 is formed in the first chamber R1 and a second port p2 is formed in the second chamber R2, and each of these ports is connected to a predetermined air-drive unit. In the present configuration, inner pressure generated by different air springs AS is applied to both sides of the piston P, and differential pressure as the result of difference between the inner pressure on the right and left sides of the piston P serves as a force required to displace the piston P. This reduces forces to be contributed by the motor M and the piston P.

An actuator is more advantageous when the actuator includes, as in the present embodiment, two spaces formed by the cylinder S and the piston P, that is, the first chamber R1 and the second chamber R2. In other words, by configuring the single motor M to cause one or two drive shafts 3 to reciprocate along the shaft center X, the first chamber R1 and the second chamber R2 can alternately be expanded or contracted at different phases. Thus, the actuator is widely applicable to a drive mechanism or the like, such as an air suspension device, that utilizes increase and decrease of a pair of pressure.

### Driving Force Transmission

As illustrated in FIG. 2 and FIG. 3, an end of the first shaft 31 is threadedly connected with the externally threaded shaft 2 having an external thread 2a on an outer periphery thereof. With this configuration, the externally threaded shaft 2 constitutes a part of the drive shaft 3. Compared to a structure of a common mechanism in which an output shaft of the motor M and the drive shaft 3 of the piston P are coupled using a separate gear or the like, the present configuration significantly reduces a length of the mechanism along the shaft center X. Thus, the compact actuator A can be achieved.

A rotor shaft 1 has a hollow cylindrical structure. An internal thread 1a that is threadedly engaged with the external thread 2a is formed on a part of an inner surface of the rotor shaft 1. The externally threaded shaft 2 is inserted inside and threadedly engaged with the internal thread 1a with the shaft centers X thereof coincident with each other. The externally threaded shaft 2 reciprocates in conjunction with rotational motion of the rotor shaft 1.

In the present configuration, the rotor shaft 1 that is a constituent member of the motor M is used as a member for converting rotational motion of the motor M into reciprocating motion of the piston P, which enables the mechanism to be simplified.

The externally threaded shaft 2 integrated with the drive shaft 3 penetrates through the rotor M1 having the hollow structure, and the externally threaded shaft 2 and the rotor M1 overlap along a direction of the shaft center X. Generally speaking, a mechanism including a piston requires a space for reciprocating motion of a drive shaft or the like that causes the piston to reciprocate in addition to a space for arranging the cylinder in which the piston is housed, and thus, the mechanism requires an enclosure for the device of a predetermined size. However, the present configuration enables a size of the device to be downsized because an internal space of the rotor M1 can be used as a part of a space for reciprocating motion of the drive shaft 3.

In addition, a part of the drive shaft 3 is threadedly engaged with a part of the rotor M1 and shaft centers X thereof are coincident with each other. Therefore, the rotor M1 has a function of a member that converts rotational motion of the rotor M1 itself into reciprocating motion of the drive shaft 3. Furthermore, compared to a structure of a common driving force transmission mechanism in which an output shaft of the motor and the drive shaft of the piston, which are arranged in series or in parallel, are coupled using a separate gear or the like, a length or a width of the mechanism is significantly reduced. Thus, the compact actuator A can be achieved.

As illustrated in FIG. 2 and FIG. 3, in between one end of the externally threaded shaft 2 and the first housing H1, a rotation restriction unit 6 is provided in such a way that the externally threaded shaft 2 does not rotate relative to the first housing H1 but reciprocates. The rotation restriction unit 6 is constructed of a convex member 6a and a groove portion 6b. The convex member 6a is shaped in such a way as to protrude radially in at least one direction at one end of the externally threaded shaft 2. The groove portion 6b is formed longitudinally along the shaft center X of the external thread 2a in an inner surface of a cylindrical space of the first housing H1 in such a way that the convex member 6a is engaged with the groove portion 6b. Integrally forming the groove portion 6b in the first housing H1 prevents increase of the number of parts and the first housing H1 can be downsized.

The rotor shaft 1 is supported at both ends by two bearings 7 in the first housing H1. One of the bearings 7a that is farther from the cylinder S is configured in such a way as to have higher load capacity than the other bearing 7b. The internal thread 1a is formed on an inner surface of the bearing 7a. The internal thread 1a is formed on a part of the rotor shaft 1 along a longitudinal direction, and forming the internal thread 1a at this position enables the present device to be compact.

In other words, considering the stroke of the piston P, the internal thread 1a is preferably threadedly engaged with the external thread 2a at the center thereof when the piston P is in a neutral state. FIG. 2 illustrates the present device when the piston P is in the neutral state. In this state, the motor M is disposed between the center of the external thread 2a in a length direction thereof and the cylinder S. In this configuration, the large-diameter first housing H1 that accommodates the motor M and the large-diameter cylinder S are disposed adjacent to each other, and a total length of sections having a large diameter becomes short.

If the internal thread 1a is formed on an end of two ends of the rotor shaft 1, the end being closer to the cylinder S, the motor M is disposed on the opposite side with respect to the position of the internal thread 1a illustrated in FIG. 2, that is, on the right side of the internal thread 1a. In other words, half the length of the externally threaded shaft 2 sticks out, and the motor M and the cylinder S are separated farther by this distance. With the first housing H1 and the cylinder S, both of which have a large diameter, disposed at a distance, a size of the entire device becomes larger and downsizing of the device cannot be achieved.

For both cases described above, the length of the entire device is the same, but a sense of compactness of the entire device is significantly different because of arrangement of the large-diameter sections. Thus, the configuration as illustrated in FIG. 2 can achieve the actuator A that is easily attachable to the vehicle B.

In the present configuration, a ball screw 8 is used for threadedly engaging the external thread 2a with the internal thread 1a. In this manner, relative rotation between the rotor shaft 1 and the externally threaded shaft 2 becomes smooth and resistance to motion decreases. In addition, the externally threaded shaft 2 is less likely to be driven by the rotation of the rotor shaft 1, and resistance to sliding of the externally threaded shaft 2 relative to the first housing H1 at the rotation restriction unit 6 decreases. Thus, the actuator A can be achieved, which has an improved efficiency of transmission from the rotor shaft 1 to the externally threaded shaft 2 and excellent responsiveness to motions and generates less vibration and little noise. It is to be noted that a screw having a trapezoidal thread may be used instead of the ball screw 8.

### Second Embodiment

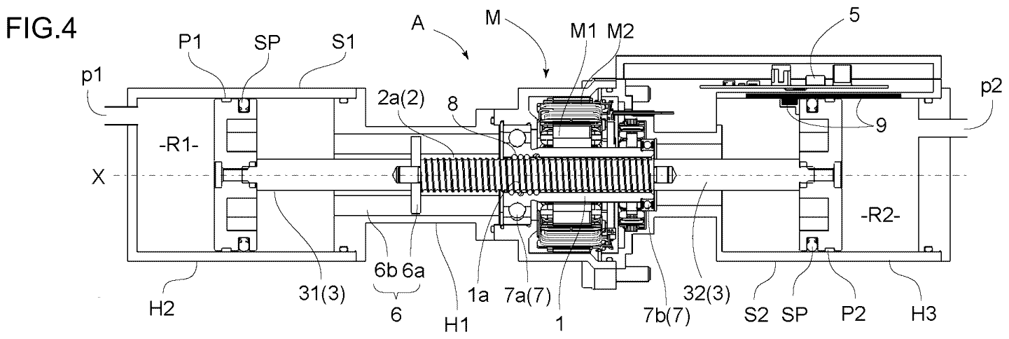

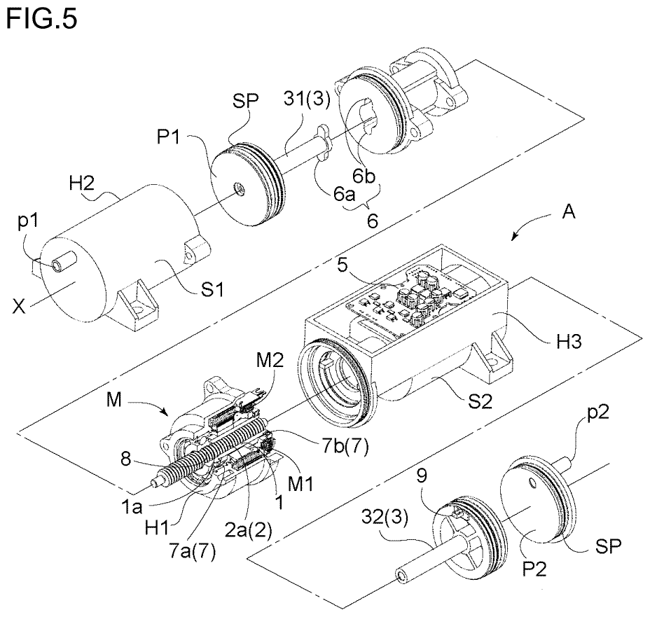

An actuator A according to a second embodiment is illustrated in FIG. 4 and FIG. 5. The present embodiment is an example in which a cylinder S and a piston P that together form a single space are provided at opposing positions across the motor M. As the cylinder S, a cup-shaped first cylinder S1 and a similarly cup-shaped second cylinder S2 are connected to the first housing H1 in which the motor M is provided.

An externally threaded shaft 2 serving as the drive shaft 3 is disposed in and penetrates through the rotor shaft 1, and a first piston P1 provided in the first cylinder S1 is attached to one end of the externally threaded shaft 2 and a second piston P2 provided in the second cylinder S2 is attached to the other end of the externally threaded shaft 2. The first piston P1 is connected to the externally threaded shaft 2 through a first shaft 31 and forms a first chamber R1 together with a wall of the first cylinder S1. The second piston P2 is connected to the externally threaded shaft 2 through a second shaft 32 and forms a second chamber R2 together with a wall of the second cylinder S2. A side of the first piston P1 that faces toward the motor M and a side of the second piston P2 that faces toward the motor M are open to the atmosphere. A first port p1 is provided in the first chamber R1 and a second port p2 is provided in the second chamber R2.

As illustrated in FIG. 4, the convex member 6a and the groove portion 6b that serve as the rotation restriction unit 6 for the externally threaded shaft 2 are provided on the side of the first cylinder S1. The first housing H1 in which the motor M is provided is connected to the second housing H2 in which the rotation restriction unit 6 is provided. The first cylinder S1 is further connected to the second housing H2. On the opposite side, the second cylinder S2 is connected to the first housing H1. The second cylinder S2 is connected at a radially outward position to a third housing H3 in which the control board 5 is provided.

In the present configuration, although the first piston P1 provided on one side of the motor M and the second piston P2 provided on the other side of the motor M are concurrently actuated, the rotor M1 just has to rotationally drive the externally threaded shaft 2 serving as the drive shaft 3, and the mechanism does not become complex.

The first cylinder S1 and the second cylinder S2 are cup-shaped and the first chamber R1 or the second chamber R2 is formed on only one side of the piston P. Therefore, in order to ensure airtightness, a piston seal SP just has to be provided on an outer periphery of each of the first piston P1 and the second piston P2, and sealing is not required for sliding sections of the first shaft 31 and the second shaft 32. Thus, airtightness of the entire device can be ensured very easily, which enables a reasonable actuator A to be achieved.

### Industrial Applicability

The actuator according to this disclosure includes a cylinder in which a piston is provided and a motor, and the actuator is widely applicable as an actuator configured in such a way as to reciprocate and drive the piston by means of rotary drive of the motor.

An actuator includes: a motor including a stator and a rotor; at least one cylinder disposed adjacent to the motor; and a piston attached to a drive shaft and provided in the cylinder, wherein the rotor has a hollow structure and the drive shaft is housed in the rotor in such a way that a part of the drive shaft is threadedly engaged with a part of the rotor while shaft centers thereof are coincident with each other, and the drive shaft is configured to reciprocate along the shaft center in conjunction with rotation of the rotor.

The actuator having this configuration has a structure in which the drive shaft penetrates through the rotor having the hollow structure, and the drive shaft and the rotor overlap with each other along a direction of the shaft centers. Generally, a mechanism including a piston requires a space for reciprocating motion of a drive shaft or the like that causes the piston to reciprocate in addition to a space for arranging the cylinder in which the piston is housed, and thus, the mechanism requires an enclosure of a predetermined size for the device. However, this configuration enables a size of the device to be downsized because an internal space of the rotor can be used as a part of a space for reciprocating motion of the drive shaft.

In addition, a part of the drive shaft is threadedly engaged with a part of the rotor while shaft centers thereof are coincident with each other. Therefore, the rotor has a function as a member that converts rotational motion of the rotor itself into reciprocating motion of the drive shaft. Furthermore, compared to a structure, such as a common driving force transmission mechanism, in which an output shaft of a motor and a drive shaft of a piston, which are arranged in series or in parallel, are coupled by using a separate gear or the like, a length or a width of the mechanism are significantly reduced. Thus, a compact actuator can be achieved.

The actuator may include two spaces formed by the cylinder and the piston.

Examples of this configuration including two spaces include two types of configurations: a configuration in which two pairs of a cylinder and a piston are provided and each of the pair forms one space; and a configuration in which a single piston divides an internal space of a cylinder into two. It is noted that only one motor is provided in both configurations.

Therefore, in these configurations, by configuring a single motor to cause one or two drive shafts to reciprocate along a shaft center thereof, the two spaces can be alternately expanded or contracted at different phases. Thus, the actuator having this configuration is more advantageous for a drive mechanism or the like that utilizes increase and decrease of a pair of pressure.

The actuator may include a single cylinder as the cylinder, in which the piston is disposed in such a way as to partition an inside of the cylinder into a first chamber and a second chamber, wherein an external thread formed on a part of the drive shaft may be threadedly engaged with an internal thread formed on a part of an inner surface of the rotor, and the internal thread may be provided at an end of two ends of the rotor along the shaft center, the end being farther from the cylinder.

In an actuator including a single cylinder as in this configuration, the drive shaft is often attached to the piston, and the piston is caused to reciprocate around the center of the cylinder serving as a reference position. In this case, since the external thread reciprocates relative to the internal thread, the internal thread is preferably positioned at the center of the external thread when the piston is at the reference position. Since the internal thread is formed at one end of the rotor along a direction of the shaft center, the center of the external thread is located at this position.

Therefore, when the piston is at a neutral position, the entire drive shaft is inserted deeply into the rotor toward a side of the internal thread. As a result, the cylinder and the motor are arranged closer to each other and a length of the actuator along the shaft center is reduced, which enables a more compact actuator to be achieved.

The actuator may include a first cylinder and a second cylinder as the cylinder with the motor disposed in-between, both of which are cup-shaped and open toward the motor, wherein the drive shaft may penetrate through the rotor, and one end of the drive shaft may be connected to a first piston provided in the first cylinder and another end of the drive shaft may be connected to a second piston provided in the second cylinder.

In the actuator having this configuration, a cylinder and a piston are disposed on both sides of the motor. In this configuration, two pistons need to be actuated, but a mechanism of the rotor for driving the drive shaft that holds both the first piston and the second piston is not complicated.

In this configuration, cup-shaped cylinders are used as the first and second cylinders. When the piston is provided in the cylinders, a space sandwiched between the piston and a bottom of the cylinder forms a chamber and an opposite space may be open to the atmosphere.

In this case, for achieving a sealing structure of the chamber, airtightness between an outer surface of the piston and an inner surface of the cylinder just has to be ensured, and no special consideration is required for the drive shaft. Thus, airtightness of the entire device can be ensured very easily, which enables a reasonable actuator to be achieved.

The actuator may have a structure in which a ball screw is used for the threaded engagement and rotation of the drive shaft about the shaft center is restricted.

By using a ball screw as in this configuration, resistance to motion due to rotation of the rotor relative to the drive shaft decreases. Therefore, the drive shaft is less likely to be driven and rotate according to rotation of the rotor, and reciprocating motion of the drive shaft that is restricted from rotating becomes smooth. Thus, an actuator can be achieved, which has an improved transmission efficiency and excellent responsiveness to motion and generates less vibration and noise.

The actuator may have a configuration in which each of the two spaces is connected to a chamber in each of two air suspension devices each of which is disposed in a wheel of a vehicle.

According to this configuration, the chambers connected to the two spaces may be chambers associated with left and right wheels or front and rear wheels of the vehicle. When the chambers are associated with left and right wheels, by pressurizing the chamber located outside and depressurizing the chamber located inside while the vehicle is turning, an attitude of the vehicle during rolling can be controlled to reduce change in the attitude. In contrast, when the chambers are associated with front and rear wheels, by depressurizing the chamber associated with the front wheel and pressurizing the chamber associated with the rear wheel while the vehicle is climbing a level difference, the attitude of the vehicle during pitching can be controlled to reduce change in the attitude.

This configuration can reduce thrust of the motor being generated while pressurizing one chamber and depressurizing another. For example, while the vehicle is turning, since the vehicle is inclined to outside, the chamber located outside is pressurized, which causes a vehicle height to be decreased, and the chamber located inside is depressurized, which causes a vehicle height to be increased. In this case, in order to stabilize the attitude of the vehicle, the motor is driven to displace the piston, and differential pressure generated in the chambers just needs to be the same as the differential pressure to be generated in the left and right wheels. Thus, this configuration can reduce load on the motor and downsize the actuator.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An actuator comprising:
a motor including a stator and a rotor;
at least one cylinder being disposed adjacent to the motor; and
a piston being attached to a drive shaft and provided in the cylinder, wherein
the rotor has a hollow structure and the drive shaft is housed in the rotor in such a way that a part of the drive shaft is threadedly engaged with a part of the rotor while shaft centers are coincident with each other, and
the drive shaft is configured to reciprocate along the shaft center in conjunction with rotation of the rotor.

2. The actuator according to claim 1, wherein the actuator includes two spaces formed by the cylinder and the piston.

3. The actuator according to claim 1, wherein
a single cylinder is provided as the cylinder and the piston is disposed in the cylinder in such a way as to partition an inside of the cylinder into a first chamber and a second chamber,
an external thread formed on a part of the drive shaft is threadedly engaged with an internal thread formed on a part of an inner surface of the rotor, and
the internal thread is provided at an end of two ends of the rotor along the shaft center, the end being farther from the cylinder.

4. The actuator according to claim 1, wherein
a first cylinder and a second cylinder are provided as the cylinder with the motor being disposed in-between, and both the first cylinder and the second cylinder are cup-shaped and open toward the motor, and
the drive shaft penetrates through the rotor, and one end of the drive shaft is connected to a first piston provided in the first cylinder and another end of the drive shaft is connected to a second piston provided in the second cylinder.

5. The actuator according to claim 1, wherein a ball screw is used for the threaded engagement and rotation of the drive shaft about the shaft center is restricted.

6. The actuator according to claim 2, wherein each of the two spaces is connected to a chamber in each of two air suspension devices each of which is disposed in a wheel of a vehicle.
